(19) United States
(12) Patent Application Publication
(10) Pub. No.: US 2004/0122729 A1
(43) Pub. Date: Jun. 24, 2004

(54) Supply chain information collection systems and methods

(76) Inventors: Danny Gillespie, Austin, TX (US); John Scott King, Austin, TX (US); David Garraway, Austin, TX (US)

Correspondence Address: H. DALE LANGLEY, JR., THE LAW FIRM OF H. DALE LANGLEY, JR. PC, 610 WEST LYNN, AUSTIN, TX, 78703, US

(21) Appl. No.: 10/636,400

(22) Filed: Aug. 7, 2003

Related U.S. Application Data
(60) Provisional application No. 60/401,821, filed on Aug. 7, 2002.

(51) Int. Cl. G06F 17/60

(52) U.S. Cl. 705/10

(57) ABSTRACT

An information collection system includes a network of connected electronic communications devices. The devices permit design of a survey questionnaire. The survey questionnaire is communicated over the network to another device communicatively connected to the network. A response to the survey questionnaire is input to the device that receives the survey questionnaire. The response is communicated over the network to other devices of the network. A database saves the response with all other responses. Information from responses are compiled and processed. Reports are generated of the survey results. The system is particularly useful to rate vendors and products from vendors, for example, in a supply function or operation of an enterprise.

### BACKGROUND OF THE INVENTION

The present invention generally relates to computerized information gathering and collection and, more particularly, relates to systems and methods for automated information gathering and collection, via surveys, for supply chain resources, including ranking and grading of such resources, such as in an enterprise environment.

Large enterprises must typically have extensive and complex mechanisms and procedures for tracking vendors and purchases. Accounting systems and methods have previously been employed in these enterprises to track costs, timing, inventories, and other aspects of the supply procurement function. The focus of these prior systems and methods has been predominantly financial in scope. Limited, if any, capabilities of these prior accounting systems and methods have permitted more strategic and qualitative assessments of supply chain factors. For example, cost and timing of procured items can potentially be analyzed, by financial report reviews of accounts and inventory items. These conventional accounting systems have not, however, collected or yielded more salient facts regarding supply chain characteristics, such as, for example, information regarding quality and circumstances of service support, follow-up, response, and correction by vendors and other supply chain entities.

Although it is likely that many companies have in the past engaged in grading or assessment of vendor and supply sources and supply chain features, there has not previously been any comprehensive tool or guidance for the grading or assessment. Moreover, the collection, sorting and circulation of information among and across large corporate and dispersed enterprises, particularly regarding the supply side functions serving the enterprises, has historically been limited by limits to technology and communication capabilities. Recent developments in computers, networking, and the entire field of information technologies make possible better and further intercommunications in organizations. The developments have not previously, however, been leveraged and successfully utilized to the optimal extent. The supply function within organizations has been lacking in successful conformity, handling, and manipulation of information regarding vendors and other supply chain facts and issues.

It would, therefore, be a significant improvement in the art and technology to provide systems and methods that utilize and leverage capabilities of information technologies to successfully and usefully implement data and information gathering, assessment, analysis and review functions regarding vendor and supply chain characteristics.

### SUMMARY OF THE INVENTION

An embodiment of the invention is an information collection system The system includes a network of communicatively connected communications devices. A survey is communicated to at least one of the communications devices by at least one other of the communications devices. A response to the survey is made by the communications device. A process handles the response.

Another embodiment of the invention is a method of collecting information. The method includes designing an electronically communicable survey and transmitting the survey electronically. The method also includes responding to the survey by an electronically communicable response and transmitting the response electronically. The method further includes processing the response.

### BRIEF DESCRIPTION OF THE DRAWINGS

The present invention is illustrated by way of example and not limitation in the accompanying figures, in which like references indicate similar elements, and in which:

FIG. 1 illustrates a system for collecting information by surveys transmitted electronically and responded to electronically over a network, according to embodiments of the present invention;

FIG. 2 illustrates a method of operation of a client device of the system of FIG. 1, wherein the client device receives and responds to the survey, according to embodiments of the present invention;

FIG. 3 illustrates a method of operation of a server of the system of FIG. 1, wherein the server transmits the survey to client devices and receives responses from the client devices to the survey, according to embodiments of the present invention;

FIG. 4 illustrates a method of operation of the system of FIG. 1 in creating survey scorecards, launching the survey, making responses to the survey scorecards, and receiving and tallying the responses, according to embodiments of the present invention;

FIG. 5. illustrates a method of security validation of the system of FIG. 1, according to embodiments of the present invention;

FIG. 6 illustrates a method of administering a survey of the system of FIG. 1, according to embodiments of the present invention;

FIG. 7 illustrates a method of administering suppliers for the survey in the method of FIG. 6, according to embodiments of the present invention;

FIG. 8 illustrates a method of administering users for the survey in the method of FIG. 6, according to embodiments of the present invention;

FIG. 9 illustrates a method of administering commodities for the survey in the method of FIG. 6, according to embodiments of the present invention;

FIG. 10 illustrates a method of relating commodities to suppliers for the survey in the method of FIG. 6, according to embodiments of the present invention;

FIG. 11 illustrates a method of scorecard design for the survey in the method of FIG. 6, according to embodiments of the present invention;

FIG. 12 illustrates an exemplary scorecard format, designed according to the method of FIG. 11, and for the survey in the method of FIG. 6, according to embodiments of the present invention;

FIG. 13 illustrates a method of administering categories for the survey in the method of FIG. 6, according to embodiments of the present invention;

FIG. 14 illustrates a method of administering questions for the survey in the method of FIG. 6, according to embodiments of the present invention;

FIGS. 15a-b illustrate a hierarchical format of question ranking and rating for the survey in the method of FIG. 6, according to embodiments of the present invention;

FIG. 16 illustrates a method of launching a survey and scorecard for the survey in the method of FIG. 6, according to embodiments of the present invention;

FIG. 17 illustrates a method of responding to a survey via a scorecard, for the survey in the method of FIG. 6, according to embodiments of the present invention;

FIG. 18 illustrates a method of closing a survey in the method of FIG. 6, according to embodiments of the present invention;

FIG. 19 illustrates a method of reporting results of a survey, for the survey in the method of FIG. 6, according to embodiments of the present invention; and

FIG. 20 illustrates a method of reporting goals and actions, as options in the 10 survey of the method of FIG. 6, according to embodiments of the present invention.

### DETAILED DESCRIPTION OF PREFERRED EMBODIMENTS

Information Collection System

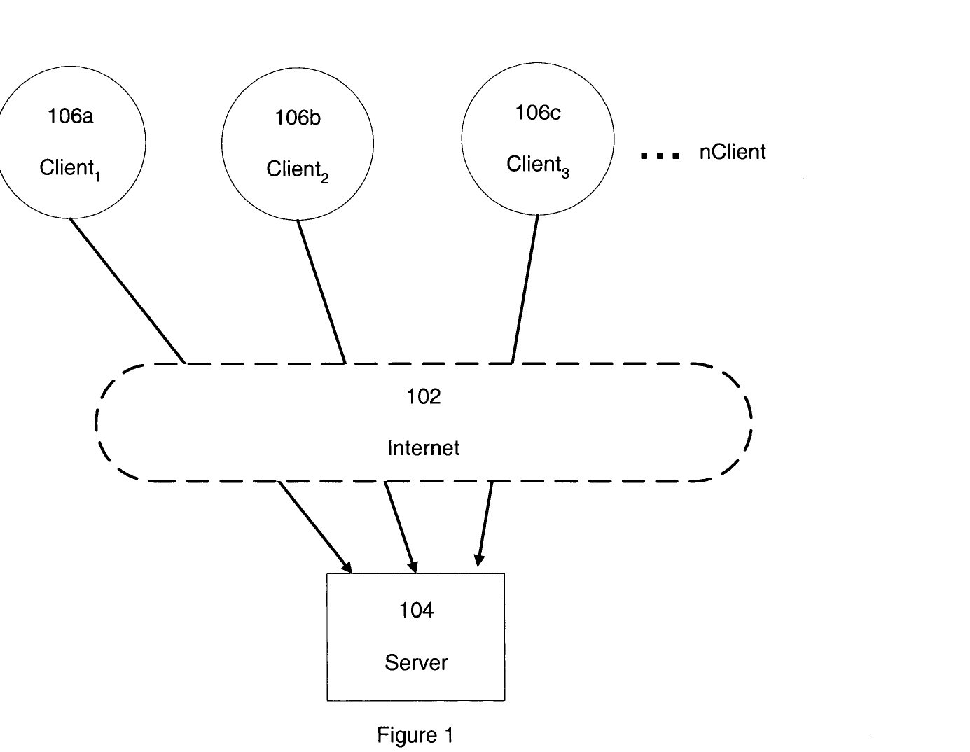

Referring to FIG. 1, a system 100 for automated information collection, manipulation and reporting includes a communications network 102, such as the Internet, an intranet, or another interconnected network of communications and computing devices. The communications network 102 includes various server and client devices, interconnected for communication over wire, wireless, other communications channel, or combinations thereof. Within the network 102, a server 104, for example a server computer, is communicatively connected to various other computing and communication devices. The server 104 maintains, either on the server 104 or associated with the server for access through the server 104, a database of information, for example, vendor identity information. The database is, for example, an Oracle, SQL, or other conventional relational database capable of storing data and yielding appropriate responses to queries.

The other computing and communications devices connected to the server 104 include, for example, at least one client device 1 06a-c (references hereinafter made to the “client device 106” are intended to include any and all such devices, whether one or more). The client device 106 is electronic communications equipment capable of communicating with the server 104 over the network 102. The client device 106 is, for example, a computer, an Internet-enabled telephone, a personal digital assistant (PDA), or some other similar device capable of communicating either over wireline, wireless, other channel, or combinations of channels. The client device 106 has a user interface for input of data to the client device 106 for communication over the network 102. The network 102, and communications among the server 104 and the respective ones of the client device 106, can be formatted to communicate according to any of a variety of communications protocols. If the network 102 is the Internet, for example, then the devices will most likely comply with the transmission control protocol/Internet protocol (TCP/IP) or some similar variant and communicated information can take the form of web pages, such as those conforming to HTML or XML standards or some Java or similar applet format. Also included within the network 102 can be various other network connection and communications devices, as is typical, such as other computing and communications devices, routers, hubs, switches, and other network and communications equipment and connections.

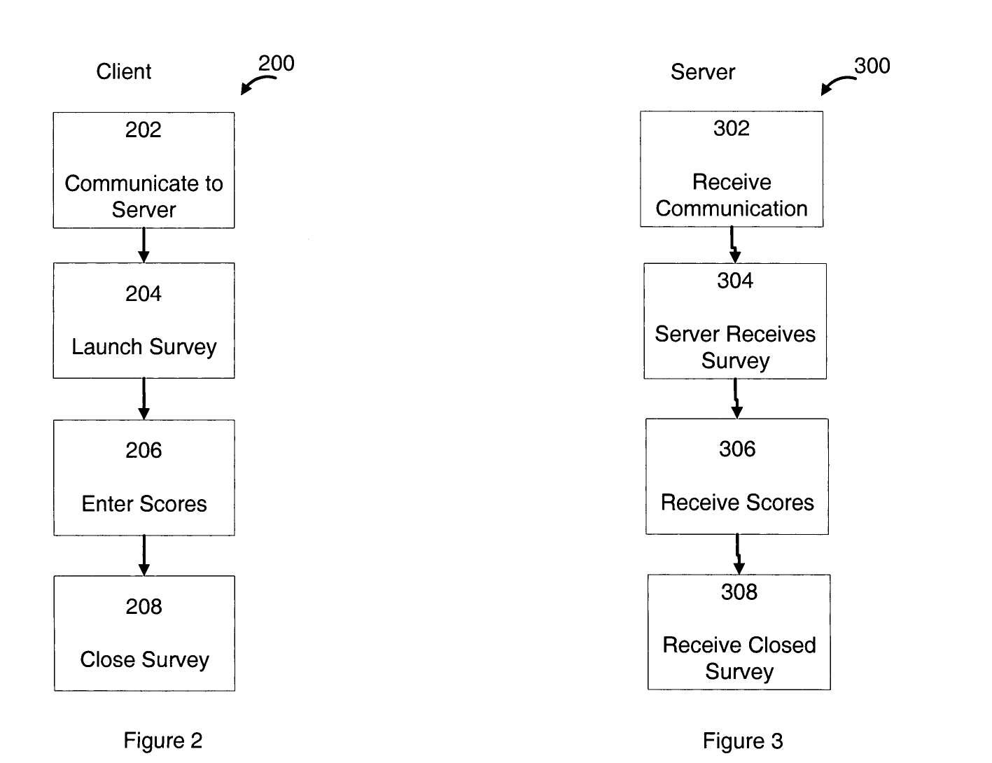

Referring to FIG. 2, a method 200 of operation of the client device 106 (shown in FIG. 1) commences with a step 202. In the step 202, the client device 106 accesses the server 104 by initiating communications under the particular protocol, such as TCP/IP. The step of accessing 202 occurs via communications over the network 102 between the client device 106 and the server 104.

In a step 204, the client device 106 receives information that includes a survey, for example, as an Internet web page containing survey queries and served to the client device 106 over the network 102. The information received by the client device 106 in the step 204 is stored on the server 104. After the client device 106 accesses the server 104 in the step 202, the client device 106 and the server 104 continue communications according to the protocol of the network 102. In the case where the protocol is TCP/IP and the information being served is a web page survey, the client device 106 receives the information and displays it to a user of the client device 106.

At the client device 106, the user inputs data, such as responses to the survey queries, in a step 206. This input of data in the step 206 can, for example, include query responses, ratings, scores and other vendor-specific statistics and data. The data is input in the step 206 directly to the client device 106 by the user, either into an active web page, text form, or other form or format. The form or format of the data entry in the step 206 is, in any event, dictated by the programmed requirements for such data, so that the data can be received and manipulated by the server 104 or its associated devices.

In connection with the step 206 of inputting data by the client device 106, the user of the client device 106 must collect the particular data. The data is collected in conventional manner, such as by a human employee or supply function equipment, but includes specific data addressing particular survey queries and permitting sufficient and complete response to those queries. In the case of vendor evaluation information, the conventional manners of collection include all conventional procedures for assessing the adequacy, timeliness, supportiveness and other aspects of vendor dealings.

In a step 208, the data input by the client device 106 is delivered to the server 104 via the network 102. The data is transferred in the step 208 according to the communications protocols of the network 102. After delivery of the data to the server 104, the client device 106 closes the survey as to the particular vendor of the then present survey queries.

Referring to FIG. 3, a method 300 of operation of the server 104 (shown in FIG. 1) commences with a step 302. In the step 302, the client device 106 transmits communications to the server 104 over the network 102 and the server 104 receives the communications. This transmitted communication of the client device 106 to the server 104 proceeds according to protocols of the network 102. The server 104, in response to the communication in step 302, transmits back to the client device 106 over the network 102 various communicated information, including a survey launch communication, in a step 304. The step 304 can include the server 104 transmitting all data to initiate and display survey queries at and on the client device 106. Alternatively, certain software for generating and employing a user interface of the client device 106 can be formatted by the transmitted communication of the step 304. For example, the communications by the server 104 to the client device 106 in this alternative can execute software stored on the client device 106, such as a pre-stored survey interface application program, or then delivered to the client device 106, such as a Java applet or other run-time program. In any event, the communications in the step 304 by the server 104 to the client device 106 initiates and causes to be displayed at the client device 106 an interface for vendor survey query and response input.

In a step 306, the server 104 receives from the client device 106, after input to the survey at the client device 106 is completed, the survey scores input to the client device 106 by the user. In effect, on completion of the input to the survey, the client device 106 transmits the survey answers over the network 102, to the server 104. The server 104 receives the scores in the step 306.

After receiving the survey scores in the step 306, the server 104, in a step 308, receives a next communication from the client device 106 indicating that the survey then being answered is to be closed. On receiving the close survey indication over the network 102, the server 104 acts to close the survey in the step 308.

Although detailed later herein, the particular methods 200, 300 of the client device 106 and the server 104, respectively, allow for survey responses for particular supply vendors to be input at the client device 106, transferred by the network 102 to the server 104, and then saved and manipulated via a database in or associated with the server 104. The database permits an administrator, via the client device 106, the server 104, or other computing device, to sort, manage and generate reports regarding the information contained in the database, such as, for example, rating or scoring reports for vendors. Numerous functions and variations are possible in the configuration, arrangement, and operation of the client device 106, the server 104, and the network 102, together with the associated database, and several specific possibilities are hereinafter described.

Vendor and Supplier Information System. Operation and Management

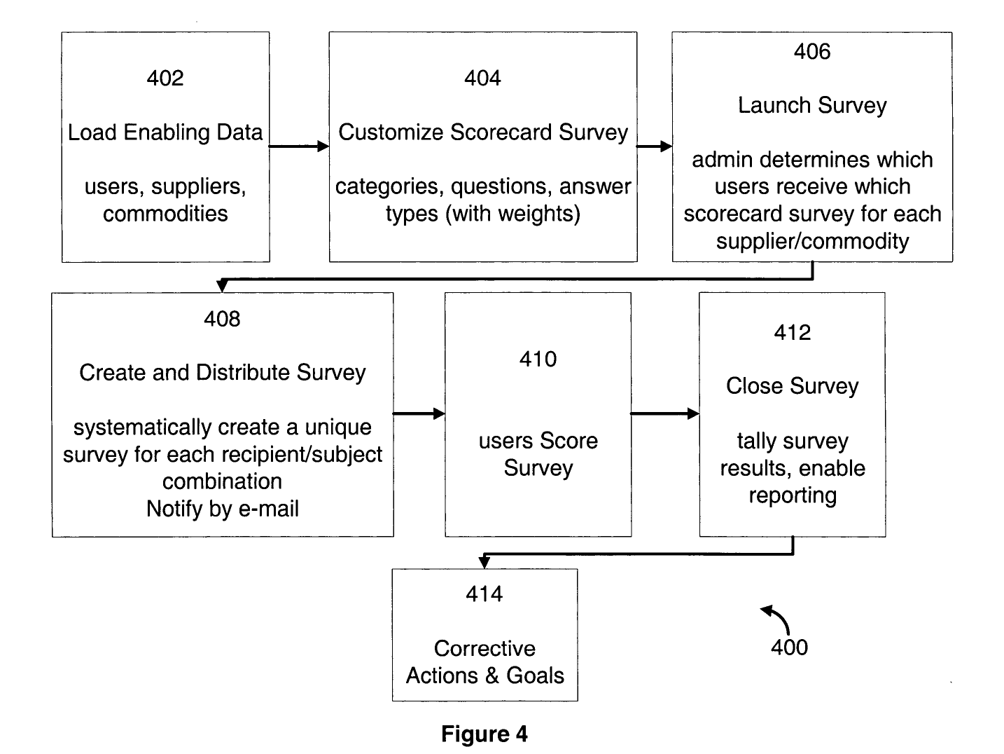

Referring to FIG. 4, a survey method 400 of the system 100 of FIG. 1 and the methods 300, 400 of FIGS. 3 and 4, commences with a step 402 of loading enabling data. In the step 402, data for each specific vendor and the products supplied by the vendor are loaded in the database of the system 100. The step 402 is performed, for example, by entries at or to the server 104, either directly or remotely from communicatively connected devices, which devices can, but need not necessarily, include the client device 106. In addition to the vendor and product information loaded in the step 402, other information can be loaded, such as data and security mechanisms for users of client devices 106, administrators of the server 104, or others permitted full or limited access to 10 the system 100 and methods 300, 400.

In a step 404, the survey format is customized. In the step 404 of customization, any user having access to the system 100, either directly to the server 104, the associated database, or via connected peripheral or device, for example, the client device 106, can create categories, questions, answer types, and other specifics for the vendor survey. The 15 access to perform the step 404 can be restricted or limited, for example, by password protection or otherwise. Moreover, even those having access to perform the step 404 can be guided and limited in the variations and extent of customization that is possible for the survey creation. Programming at the server 104 and the associated database, as well as other software applications, control and permit the customization in the step 404, as 20 appropriate for the particular use.

After the survey is created in the step 404, the survey is launched in a step 406. In the step 406, the survey is made accessible to desired users, for example, certain of the client devices 106, as applicable. An administrator of the system 100, for example, an administrator having access to program the server 104, can designate with users or devices can receive the particular surveys and which vendors and products can be addressed by such users and devices through the surveys. Programing at the server 104, or otherwise within the system 100, permits the segregation and assignment of surveys and products according to the particular user and device, as appropriate and desired in the particular application.

A next step 408 of launching the survey occurs when a user, such as the client device 106, notifies the server 104 that a survey is requested and to be answered. In the step 408, the system 100 provides to the client device 106, by communications from the server 104 to the client device 106, a systematically created unique survey for the particular user and the vendor and product that is applicable. The user is notified, for example, by the server 104, that the unique survey has been created. The notification can be by e-mail communication from the server 104 to the client device 106. Alternately, the notification can be by other means, such as the client device 106 can access a particular web page or other information available from the server 104.

Once the notification is received or otherwise accessed over the network 102 by the client device 106 from the server 104, the user of the client device 106 inputs responses to (or “scores˜˜) the survey appearing at the client device 106. The inputs at the client device 106 can take a variety of forms, such as completion of fill-in-the-blank textor HTML forms, multiple choice answer input by clicking or otherwise indicating answers, or by any other available means for input of information in response to survey queries appearing at the client device 106. Upon completion of input at the client device 106, the survey scores are transmitted by the client device 106 over the network 102, back to the server 104 or other storage component of the system 100. The scores so transmitted by the client device 106 are stored and input to the database, for manipulation and analysis by employing available database querying and reporting tools.

After the step 410 of transmitting the scores by the client device 106, the survey is 5 closed at the client device 106, the server 104 and other aspects of the system 100. The survey scores are then tallied together with all other survey scores, for example, by the database in connection with the server 104. Reporting and other conventional aspects of database manipulation, analysis and display of data are then possible, in accordance with conventional practices.

In a step 414, corrections and modifications can be made to the surveys, to ensure survey completion, and to otherwise provide for any desired changes.

Security

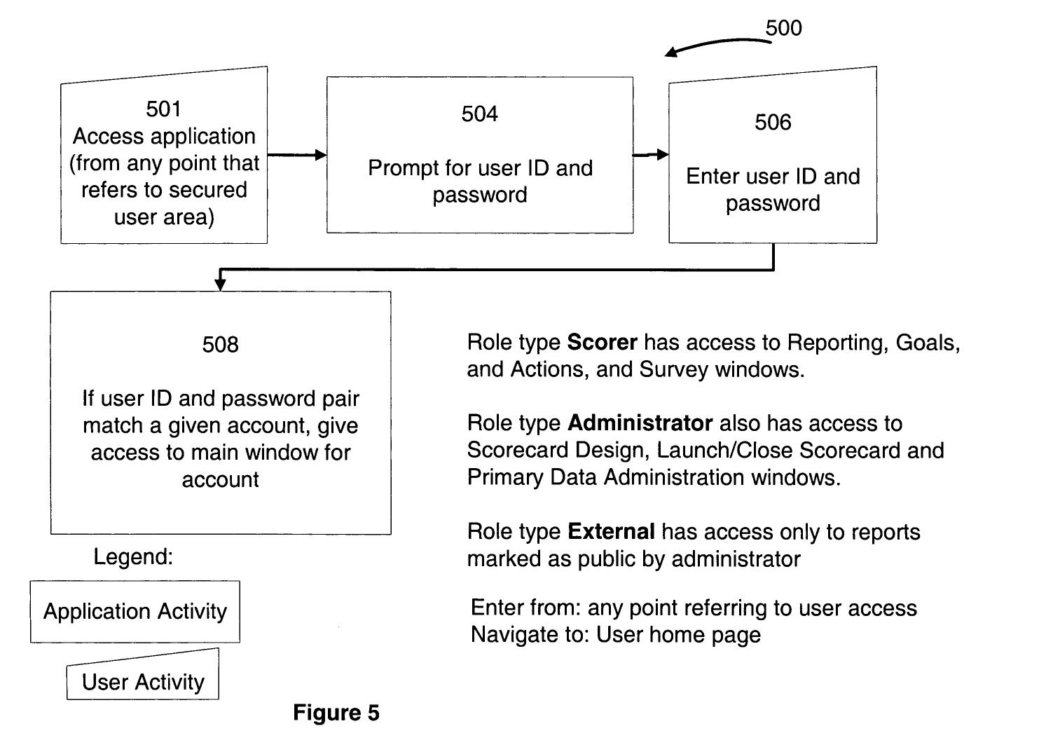

Referring to FIG. 5, security methods 500 for server 104 and client device 106 access to surveys, communications, databases, and other features can be accessed in a step 502. On access to the system 100 and methods 300, 400, a prompt is displayed on the device of the accessor, for example, on the client device 106 or the server 104 or other connected peripheral or display. In a step 506, a user identification and password is entered in the device of the accessor. The identification and password are then transmitted over the network 100 to other devices of the system 100, or on the device of the accessor itself, and in a step 508 are compared by lookup to a database of authorized user information. If the identification and password are found in the lookup operation, then access to use the system 100 and methods 300, 400 is permitted the accessor over the accessor's device.

System Administration Procedures

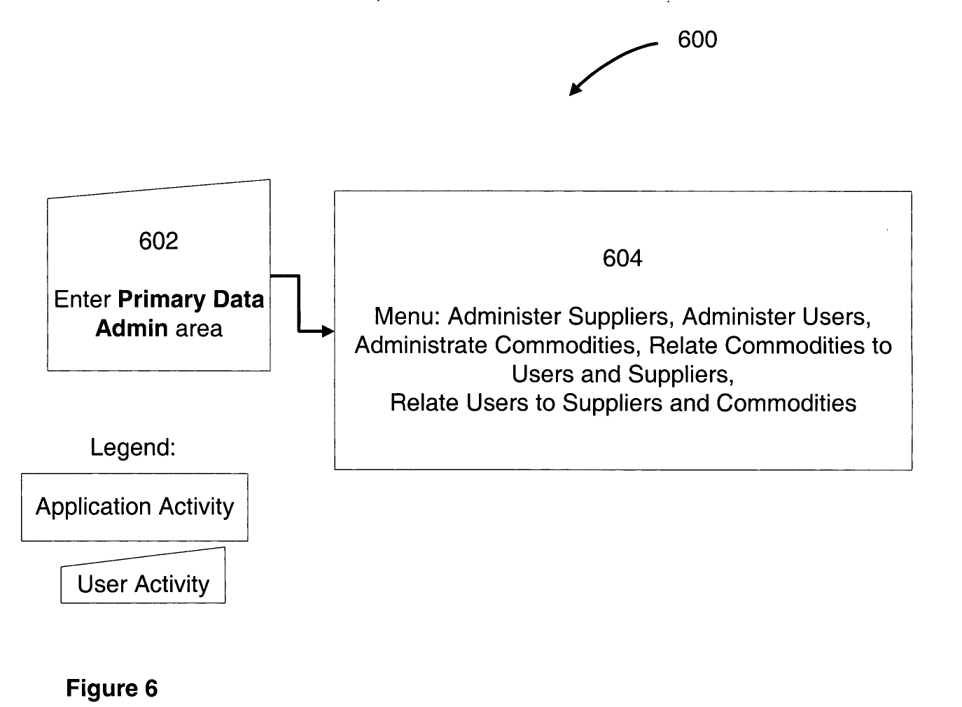

Referring to FIG. 6, on passing security clearances of the system 100, an authorized accessor can perform administration of the system 100 and the methods 300, 400, in accordance with a method 600. The method 600 is initiated with a step of entering a primary data administration area provided by accessing the server 104, either at the server 104 or remotely, as applicable. The server 104 then returns in a step 604 a menu giving administration options.

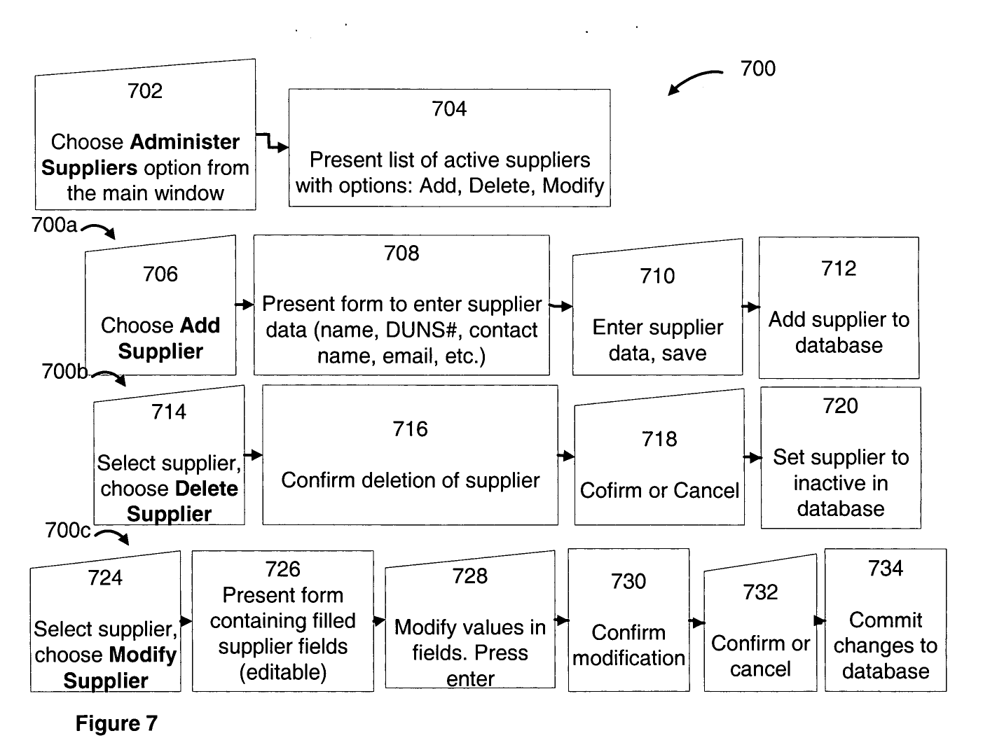

Referring to FIG. 7, in conjunction with FIG. 6, each of the menu options is presented, as the method 700, including sub-methods 700a, 700b, and 700c, respectively. In the method 700, administration of vendors/suppliers is accomplished. The method 700 is initiated by the accessor administrator by a step 702 of selecting “Admin Suppliers”. On such selection, the administrator is presented with additional options, for example, lists of active vendors and Add, Delete or Modify functions.

If the accessing administrator chooses in a step 706 to Add a supplier, then a 15 method 700a proceeds. After selecting in the step 706, the administrator is presented with a form in a step 708. The form prompts the administrator for vendor/supplier data, including such matters as name, address and other vendor-specific information. In a step 710, the administrator inputs the data and saves it, for example, in a step 712 the vendor data is added to the vendor database maintained at or in association with the server 104.

If, on the other hand, the accessing administrator chooses in a step 714 to delete a vendor/supplier already maintained in the database, a method 700b proceeds. On selecting Delete, a confirmation request is presented to the administrator. The administrator can then, in a step 718, confirm the deletion (or not, as the case may be). If the administrator then confirms the deletion in the step 718, the database thereafter indicates that the particular vendor/supplier is “inactive”. A step 720 operates in conjunction with the database to identify the particular vendor/supplier as inactive, for purposes of continuing surveys.

Another option available to the accessor administrator in the method 700 is a method 700c of modifying a vendor/supplier data. A step 724 selects the method 700c. Next, the administrator is presented in a step 726 with a form containing supplier fields of information. The form is editable, and is modified by the administrator in a step 728. A request to confirm the modification is next presented to the administrator in a step 730. If the administrator confirms the modification in a step 732, the changes are then made in the database of vendor/supplier information in a step 734.

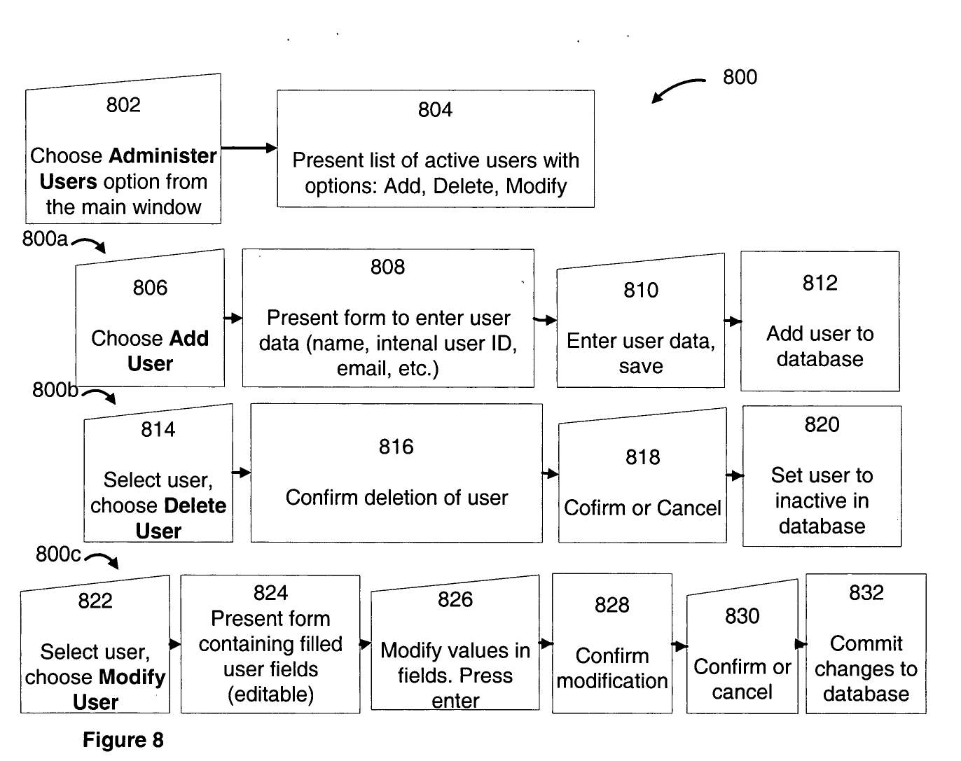

Referring to FIG. 8, in conjunction with FIG. 6, each of the menu options is also presented, as the method 800, including sub-methods 800a, 800b, and 800c, respectively. The method 800 performs administration of users of the system 100, for example, each of the client devices 106 and the server and database administrators. The method 800 is initiated by the accessor administrator by a step 802 of selecting “Admin Users”. On such selection, the administrator is presented with additional options, for example, lists of authorized users and Add, Delete or Modify functions as the users.

The accessing administrator can choose in a step 806 to Add a user. In this 20 instance, a method 800a performs the addition. After selecting in the step 806, the administrator is presented with a form in a step 808. The form prompts the administrator for vendor/supplier data, including such matters as name, address and other vendor specific information. In a step 810, the administrator inputs the data and saves it, for example, in a step 812 the user data is added to the user lookup table or database maintained at the client device 106, the server 104, or otherwise of the system

The accessing administrator can alternately choose in a step 814 to delete a user previously authorized to use the system 100, and as per the user table. In such instance, a 5 method 800b proceeds to allow selection of Delete. A confirmation request is presented to the administrator after the Delete is selected as to any user. In a step 818, the administrator can then confirm the deletion (or cancel the deletion). If the administrator confirms the deletion in the step 818, the particular user is designated as “inactive” in the lookup table and the user can no longer access the system A step 820 sets the user as “inactive” in the tables of the system.

As a further alternative, the accessor administrator can select a method 800c to modify user's information and status. In a step 822, the administrator selects to modify in the method 800c. The administrator is then presented in a step 824 with a form containing user fields of information. The form is editable, and is modified by the administrator in a step 826. A request to confirm the modification is next presented to the administrator in a step 828. If the administrator confirms the modification in a step 832, the changes are then made in a step 832 to the lookup table for users.

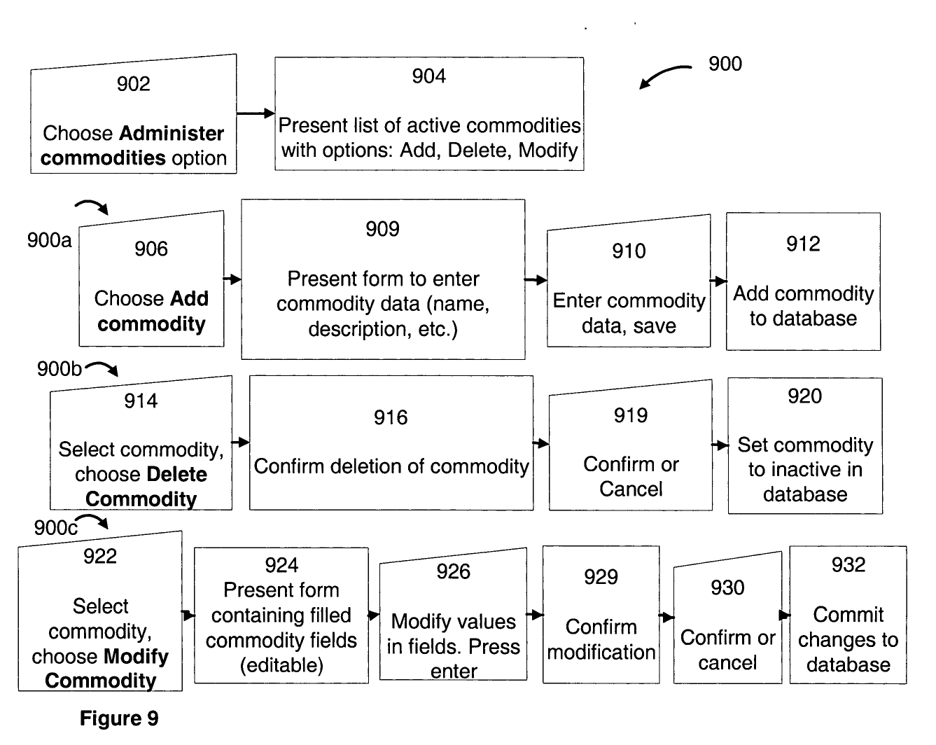

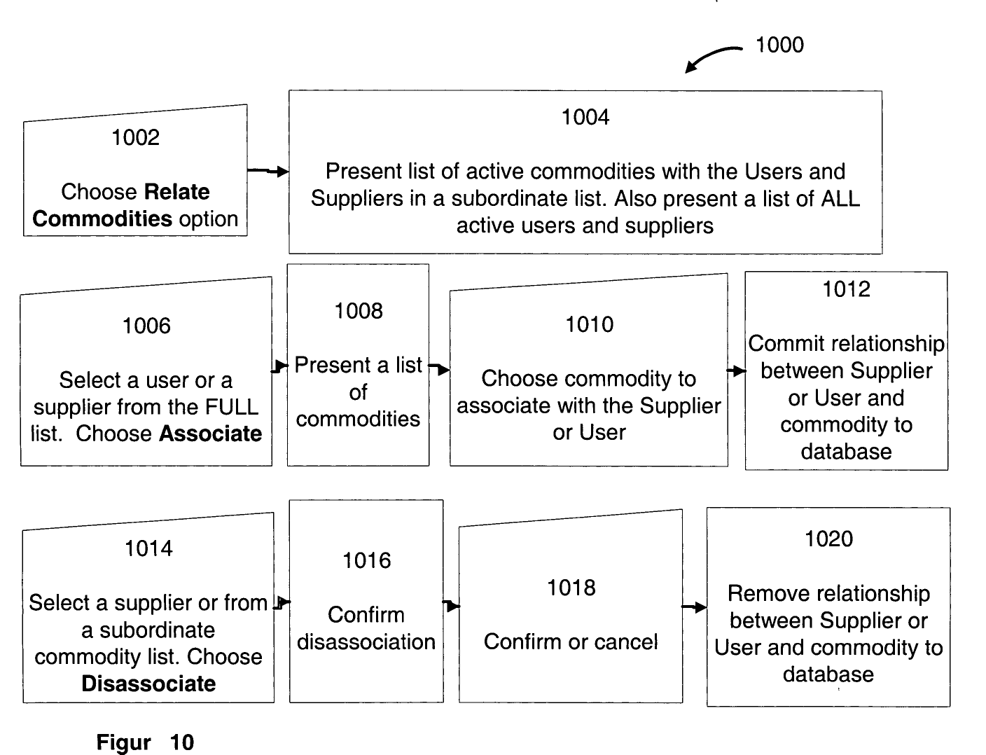

Referring next to FIG. 9, in conjunction with FIG. 6, the method 900, including sub-methods 900a, 900b, and 900c, respectively, performs administration of the particular 20 commodities purchased from the vendors with information available from the system 100. For example, the method 900 dictates what products will be included in the surveys and reporting information, and ties the products to the particular vendors within the vendor/supplier database. The method 900 commences when the accessing person, such an administrator, a user of the client device 106, or another with system 100 access authorization, selects “Admin Commodity”. The user is presented with additional options at that time, for example, lists of products surveyed and Add, Delete or Modify functions to change the surveyed products, as applicable.

The user of the system 100, such as the administrator or a user of the client device 106, can choose in a step 906 to Add a supplied product/commodity. A method 900a proceeds to perform the addition. The user is presented in a step 908 with a form for entry of commodity data. The form prompts the user for the data, for example, including such matters as product name and description. The user inputs the data in a step 910, and saves it, for example, in a step 912, to the database as a commodity for consideration for the survey.

In addition to the method 900a, the user can choose to delete a commodity/product for survey in a method 900b. The method 900b is commenced with a step 914 of Delete the commodity. In the delete step 914, a user authorized to use the system 100 can delete products from the active list in the database for being surveyed. A confirmation request is presented to the user in a step 918 in order to confirm that the Delete is appropriate, prior to actually performing the deletion. If the user confirms the deletion in the step 918, the particular commodity/product is set as “inactive” in the database for survey.

The user can, moreover, select a method 900c to modify commodity/product information and status. In a step 922, the user selects to modify the product name, description or other information. The user is then presented in a step 924 with a form containing fields of information regarding the commodity/product. The form is editable, and is modified by the user in a step 926. A request to confirm the modification is next presented to the user in a step 928, and the user can confirm or cancel the modification. If the user confirms the modification in a step 930, the changes are then made in the database for the modified information about the product in a step 932.

Relation of Commodities to Users and Suppliers

In order to permit survey rating and reporting functions regarding commodities/products and relevant vendor/suppliers, the system 100 (shown in FIG. 1) allows database associations among the various ones. A method 1000 of FIG. 10, for example, is employed to provide the appropriate and desired associations. In the method 1000, an administrator or other authorized user of the system 100 is presented with a menu option to “Relate Commodities”. In a step 1002, the user chooses the option. Thereafter, the user is presented with options to Associate or to Dissociate.

In a step 1006, the user selects a supplier or user from the active list then existing for the system 100 from the database, and also selects to Associate. The user is presented in a step 1008 with a list of then active commodities/products for the particular supplier or user that was chosen. The user can choose any particular commodity in a step 1010, and this associates the commodity with the supplier. Finally, the relationship of the commodity and supplier, as so chosen, is saved in the database in a step 1012.

Similarly, the user can dissociate related commodities and suppliers by initiating a step 1014. In the step 1014, the user selects the supplier or user and the particular commodity/product from the active listings presented from the database. Dissociate is chosen in the step 1014. The dissociation can be confirmed in the step 1016 (or otherwise cancelled). If confirmed in a step 1018, the dissociation is performed by the method 1000 by removing the relationship in a step 1020 between the particular vendor/supplier and commodity/product in the database.

Scorecards

The system 100 (shown in FIG. 1) and the methods 300, 400 (shown in FIGS. 3 and 5 4) also present options regarding survey scoring and formats, such as design of scorecards (i.e., survey request forms), administration of categories, formulation and administration of questions, management of answers to surveys, and others. Each of these options is briefly here described, with the intention and understanding that numerous variations are possible and all are included in the inventions.

Referring to FIG. 11, for example, scorecard design proceeds according to a method 1100. In the method 1100, an authorized user of the system 100 is presented in a step 1102 with an option to choose Scorecard Design. When the user chooses this option, the user is presented in a step 1104 with a configurable questionnaire for the scorecard design. The configurable questionnaire arranges questions according to a hierarchical form

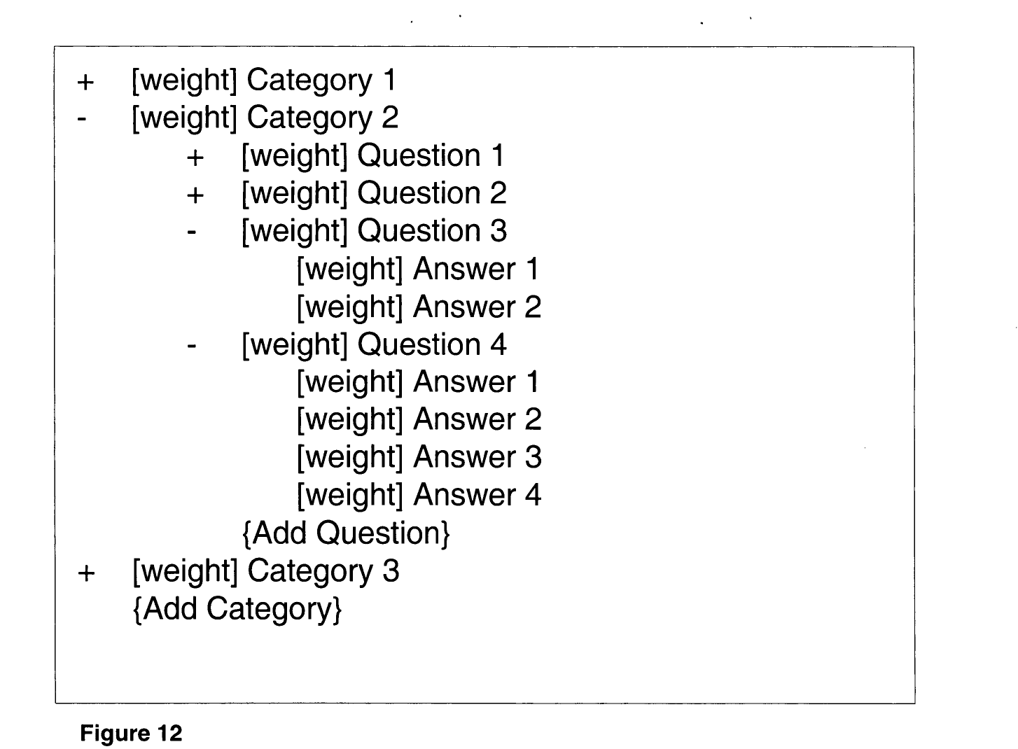

Referring to FIG. 12, an exemplary questionnaire hierarchy, substantially as presented to the user in the particular example, is illustrated. In the hierarchical format, the several categories include Category, Question, and Answer. It is notable that each element of the hierarchy has a weight and an order number. In analyzing and reporting scores of surveys by the system 100, this hierarchy allows for various weighting and distinction among commodities/products and vendors/suppliers, as desired for the usage.

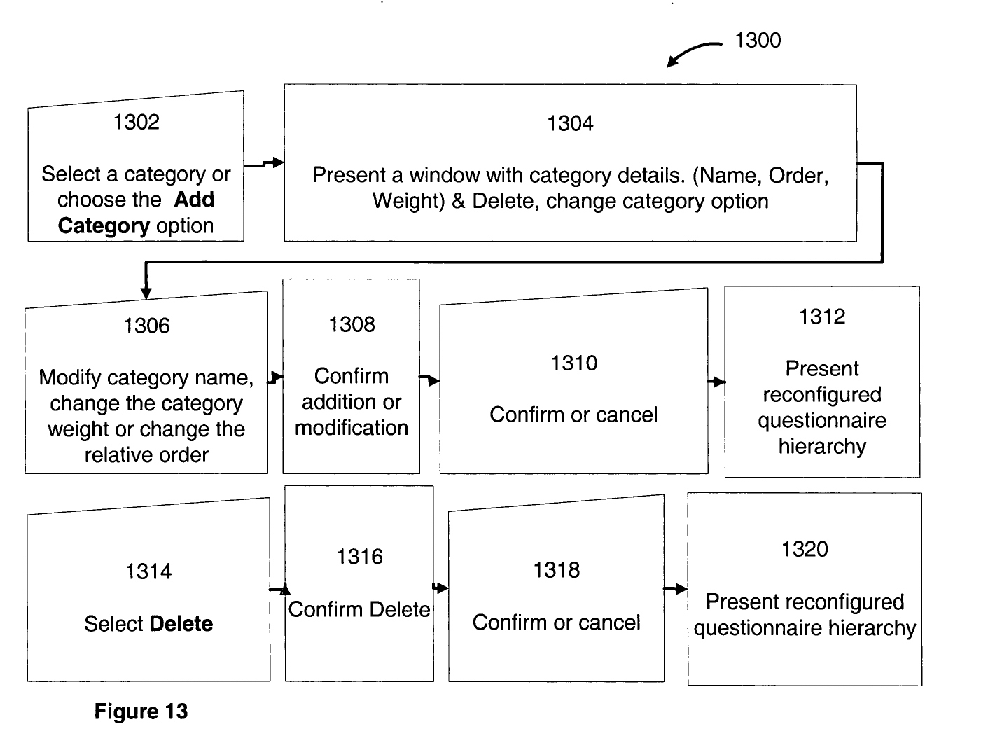

Referring to FIG. 13, a method 1300 is performed to administer the Categories of the hierarchical format of the scorecard. In the method 1300, an authorized user is presented with an option in a step 1302 to “add category”. If the user chooses the option, then the user is presented in a step 1304 with a window of Category details, such as Name, Order, and Weight. Additionally, the user is presented an option to Delete the Category. If the user chooses to modify the category in a step 1306, the user can then make modifications. The user is presented with a confirmation of the modifications in a step 1308, and on confirmation in a step 1310, the modified configuration is saved in a step 1312. If at the step 1304 the user chooses to Delete the option in a step 1314, the user is asked to confirm the delete in a step 1316. If the delete is confirmed in a step 1318, then the Category is deleted from the questionnaire hierarchy.

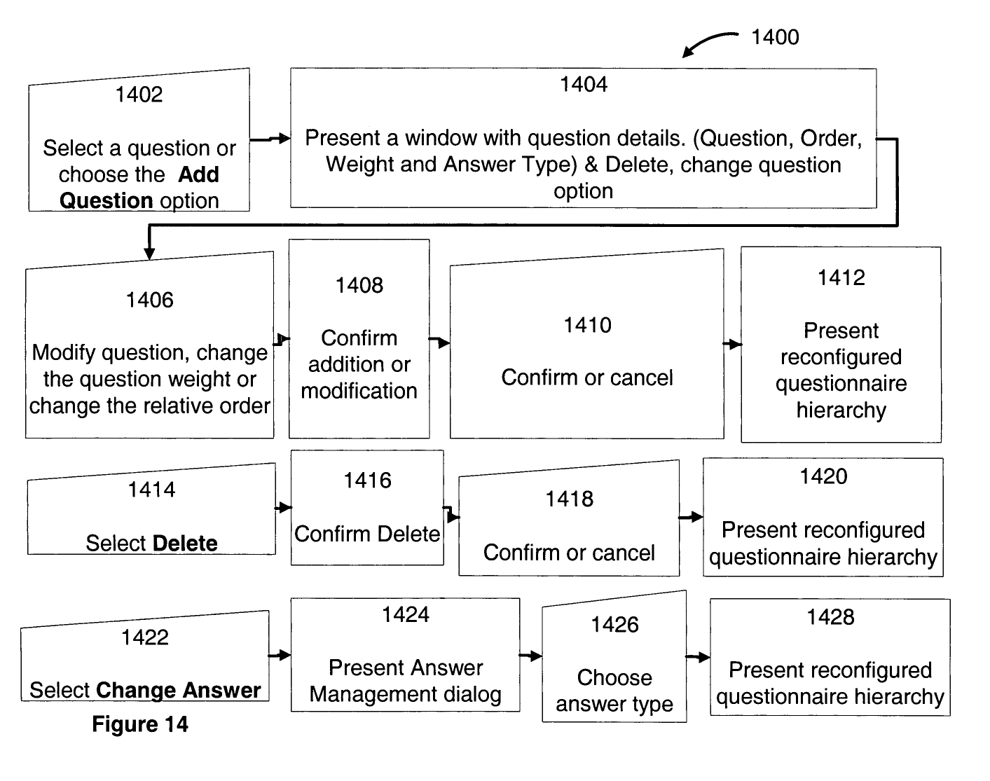

Referring to FIG. 14, a method 1400 administers questions of the scorecard. The method 1400 is commenced in a step 1402 of selecting to “add question”. The user is presented in a step 1404 with question details, such as question, Order, Weight and answer type, and is also permitted to choose Delete or change answer as options. In a step 1406, modification of a chosen question in the step 1404 occurs by the user's input to the question details. Changes can include, for example, change of question waiting, relative order, and others. A step 1408 permits confirmation of the change made, the confirmation is provided by the user in a step 1410, and the change is saved by the database in a step 1412.

If “Delete” is chosen as to the question in the step 1404, then the method 1400 20 proceeds to a step 1414 of selecting Delete by the authorized user. A prompt to confirm the delete is presented in a step 1416, the user inputs the confirmation in a step 1418, and the question is treated as deleted as saved in the database, for purposes of surveys.

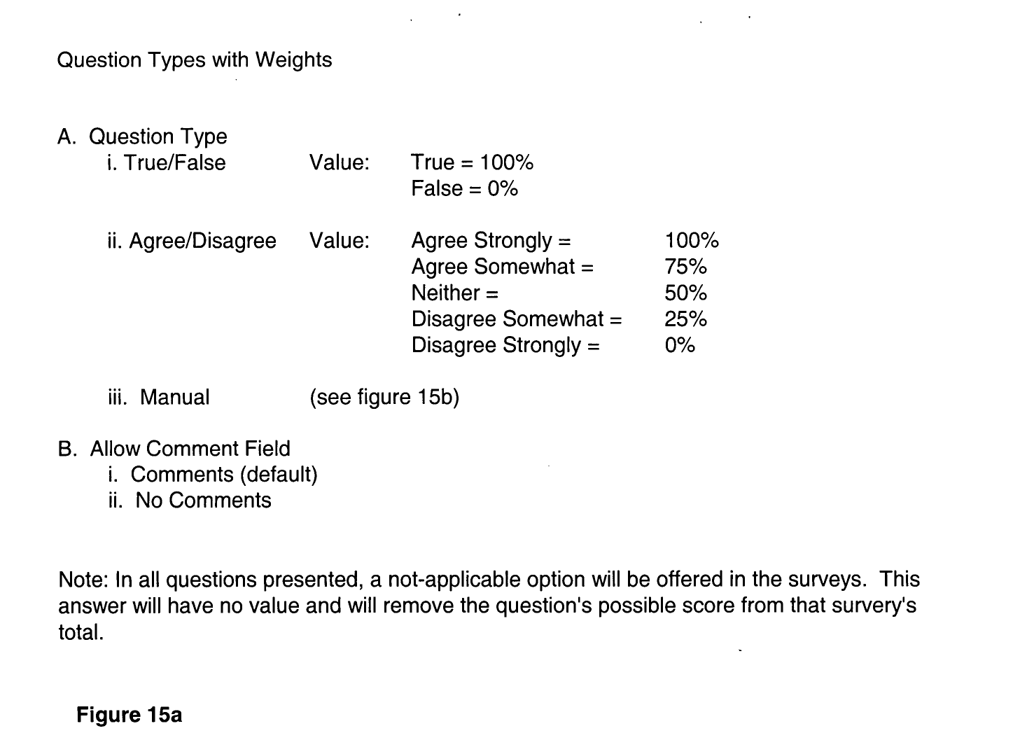

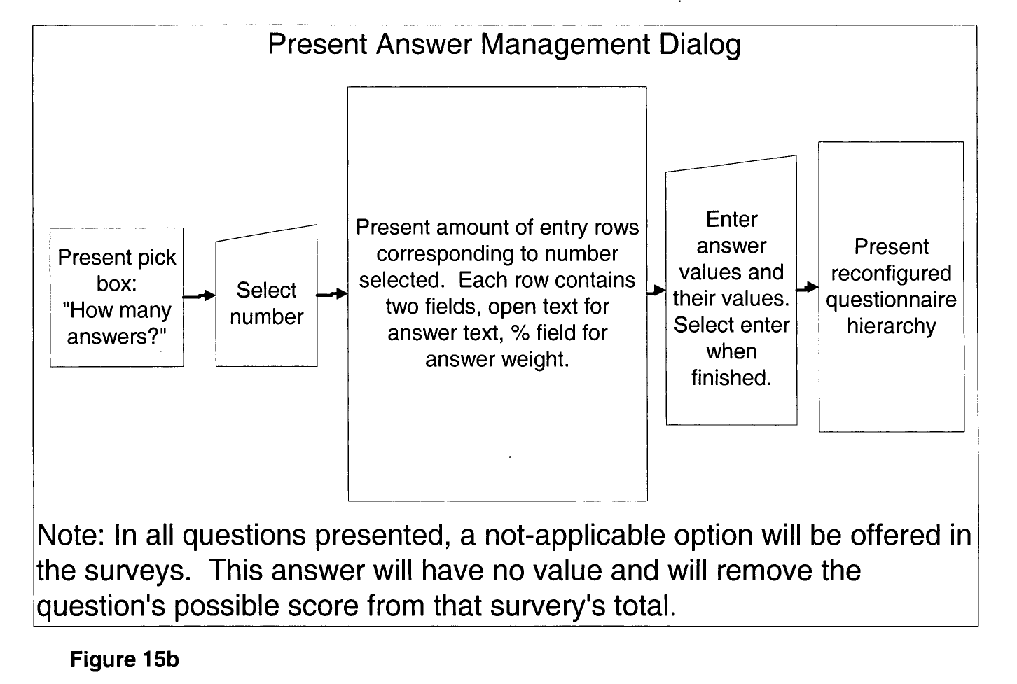

Another possible option presented to the user in the step 1404 is “change answer If the user selects to change answer in a step 1422, then the user is presented by the system 100 a Present Answer Management dialogue, for example, as illustrated in FIG. 15. Referring to FIG. 15, the presentation of the dialogue permits the user to choose an answer type in a step 1426. On choosing an answer type, the questionnaire is changed in a step 1428 in the hierarchy to permit the particular answer type in the survey.

Registering Responses to the Survey

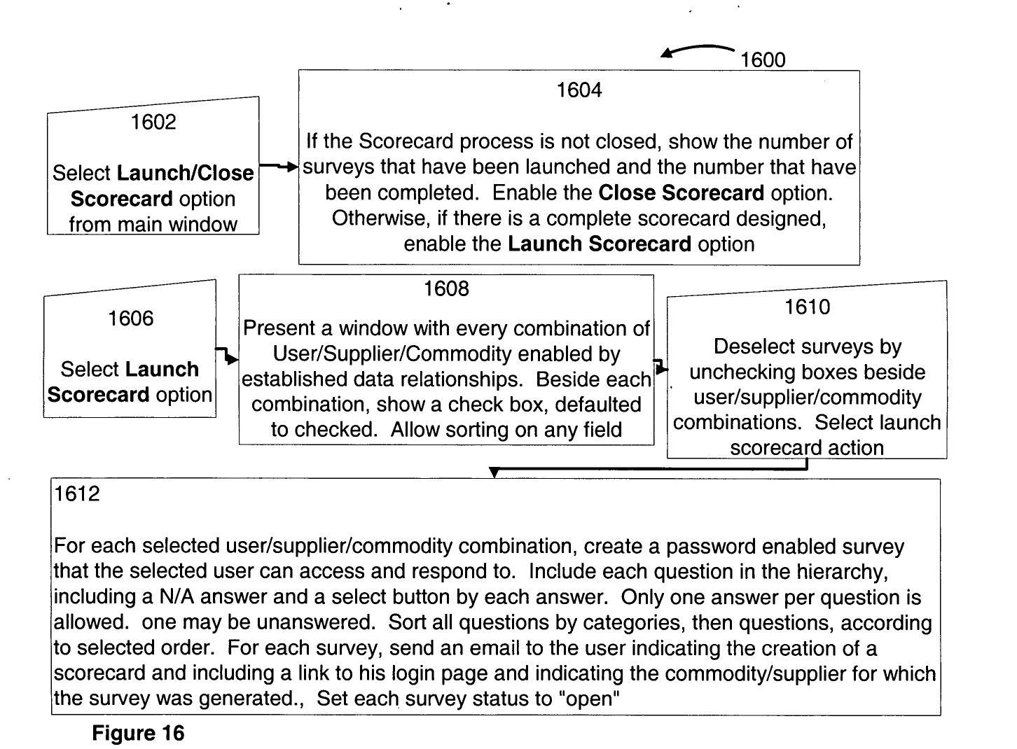

Referring to FIG. 16, a method 1600 occurs in the system 100 (shown in FIG. 1) to begin a survey and permit a users to answer to respond to the survey. In the method 1600, the user, for example, the user of the client device 106 (shown in FIG. 1), selects in a step 1602 from menu items to “Launch/Close Scorecard.” Thereafter, the user is presented, for example, on the client device 106, with certain statistics regarding the survey, as well as other options, in a step 1604. In a step 1604, Launch Scorecard is selected. The user is then presented in a step 1608 with listings of every combination of User, Supplier, and Commodity from the relationships previously established in the system 100 database. In a step 1610, particular ones of the surveys which the user wants to make available to others for response are selected by the user (or deselected, as the case may be), such as via input to the client device 106. Then, in a step 1612, the survey is begun with the password enabled access for the selected users. In the survey, the selected users score and respond only to the particular Supplier, Commodity combinations per arrangement of the particular survey, and only the selected users can do so. The survey is sent to the selected users for scoring, for example, by transmission of e-mail to or other transmission or access by the client device 106 of each user over the network 102 (shown in FIG. 1).

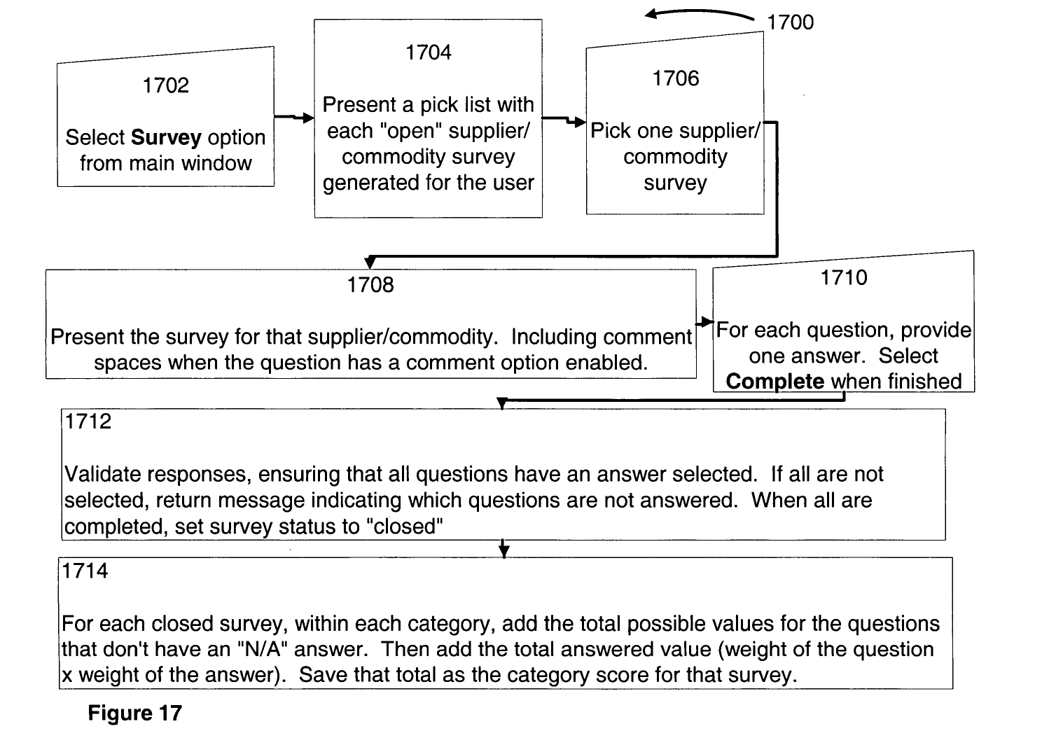

Referring to FIG. 17, each user that receives the survey questionnaire, for example, at the client device 106 can select in a step 1702 a “Survey” option to initiate response to the survey. The user is then able in a step 1704 to input to the client device 106, or other input device to the system 100, a selection of Supplier or Commodity to begin responding. In a step 1706, the user input a choice of Supplier or Commodity, via the user's input device. The user, in step 1708, is then presented, for example, on the client device 106, the survey for the particular chosen Supplier or Commodity. The user then answers the survey in a step 1710, according to the appropriate response for the particular question and answer type as set up in the scorecard design. A validation step 1712 next permits the user, via input, to confirm the answers so input, and the survey is registered as “closed”. In a step 1714, the survey responses are manipulated in various manner, such as according to question weighting or otherwise as desired according to the survey design. The step 1714 is performed, for example, by transmitting the survey responses over the network 102 from the client device 106 to the server 104, or otherwise according to the system 100 design and configuration.

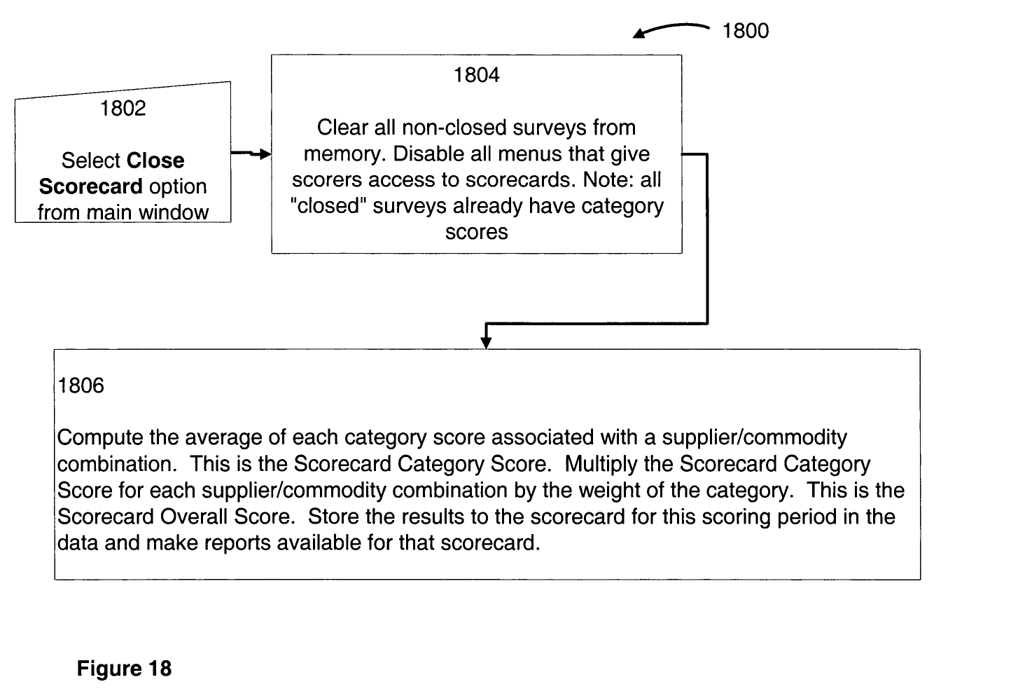

Referring to FIG. 18, a method 1800 completes the survey as to all responses then registered. In a step 1802, a user, such as an accessor administrator at the server 104, selects a “Close Scorecard” option. On making such selection, a step 1804 follows in which all non-closed surveys are then cleared from memory storage, such as from the database, and all menus and scorecards are access disabled. Computations and other manipulations of survey responses are then derived, from the aggregate of all survey responses then having been registered, in a step 1806.

Reporting Results

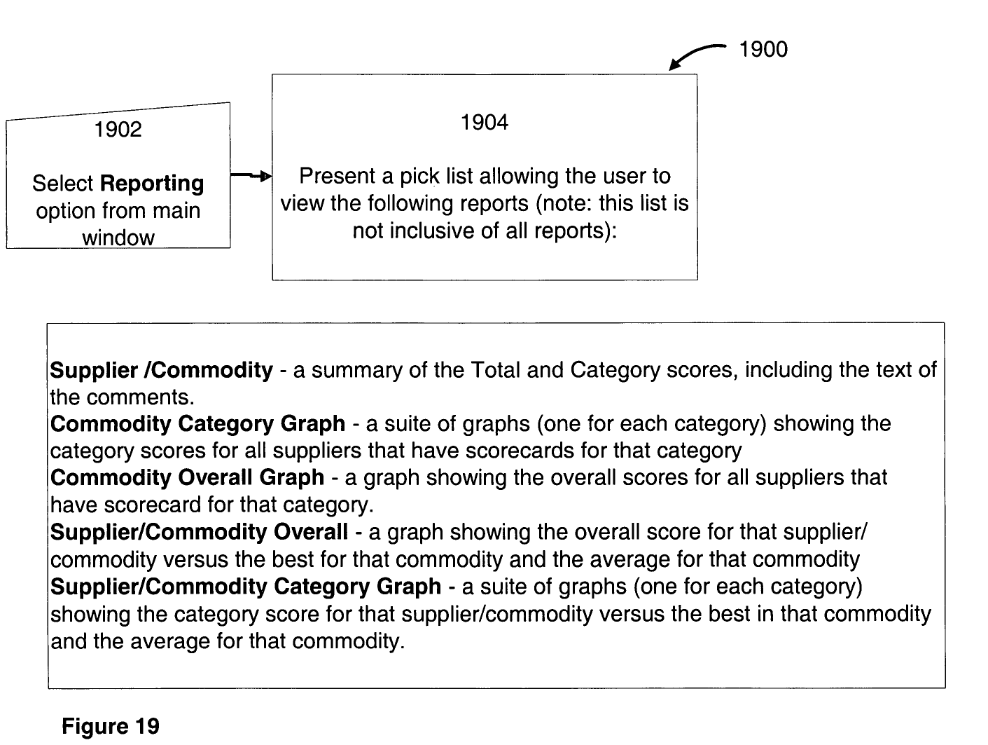

Referring to FIG. 19, a method 1900 of reporting survey results includes a step 1902 of selecting “Reporting” as an option, for example, such selection being made by communication to the server 104 or otherwise, and a step 1904 of selecting a form for the reporting, such as from among vanous pre-programmed format options or customized formats. Of course, printing and display of reports can be widely varied in format, options, and access, and all such possibilities are possible with the system 100 and the methods 300, 400.

Other Options

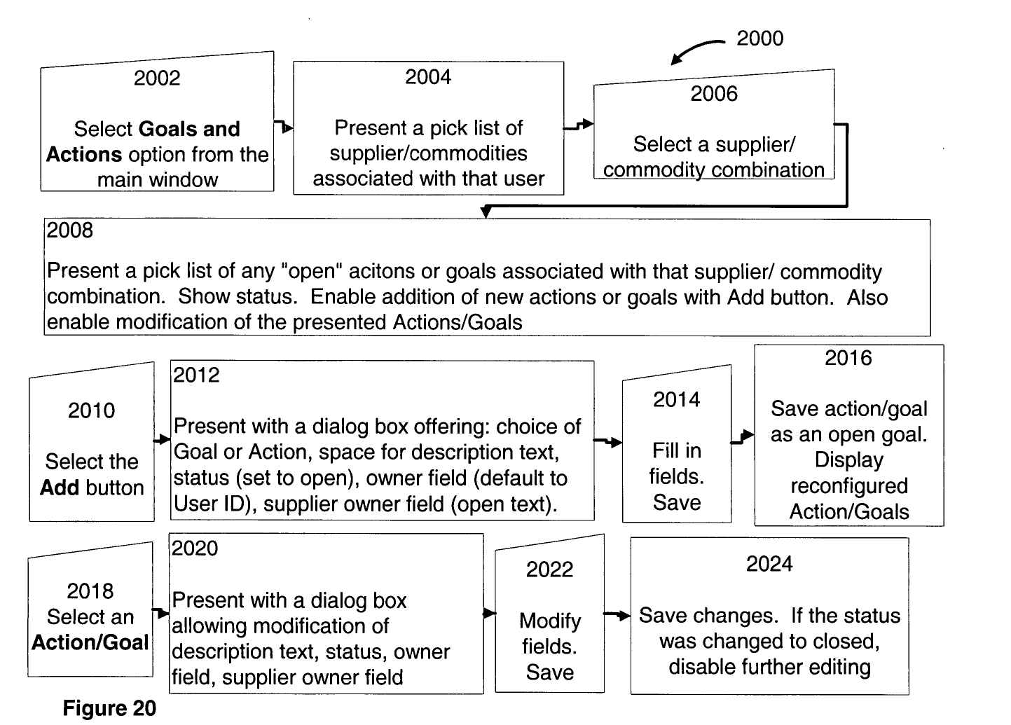

Numerous other options and features of the system 100 and the methods 300, 400 15 are possible. Referring to FIG. 20, for example, one such option is a method 2000 of presenting Goals and Actions based on surveys by the system 100. In the method 2000, a user, such as an administrator of the server 104 or other user that is authorized by the system 100, can select, via the server 104 or other user device of the system 100, an option of “Goals and Actions”. On such selection, the user is presented in a step 2005 with the opportunity to input selections of a pick list of Supplier and Commodity authorized for that user. In a step 2006, the user inputs a selection of any particular Supplier or Commodity. The user is next presented, in a step 2008, with any “open˜˜ actions or goals associated with Supplier or Commodity, and such actions or goals are discretionary in the design of the system 100 as hereafter described.

At the step 2008, the user is permitted to “Add” or otherwise select any particular Action or Goal. In a step 2010, the user inputs to the user device a selection of “Add”. The user is then presented in a step 2012 with various choices to add information, descriptions, and other information. In a step 2014, the user can input information. The input information is saved in the database of the system 100 in a step 2016.

Similarly, if the user inputs to the user device a different selection in a step 2018, the method 2000 proceeds by presenting various modification choices, in a step 2020. Modifications can then be input by the user to the user's device in a step 2022. The modifications are saved in the system 100 in a step 2024.

Of course, numerous alternatives of the foregoing are possible. For example, each of the various presentations of information and options, and the input responses thereto, can occur among any communicatively connected device of the network 102 of the system 100. It is expected that much of the survey design and administration activities will occur via the server 104 and the related database or databases, however, the system 100 can be configured to allow many, if not all, of the various methods and operations to be performed either locally or remotely, by virtue of the networked communication capabilities of the system 100. Presently, conventional network communications protocols, such as TCP/IP or others, are contemplated for the interactive communications required in the methods and operations of the system 100. Nonetheless, specialized protocols, including secured protocols and others, can be implemented in the system 100 and the methods 300, 400 in accordance with the foregoing.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An information collection system, comprising:
a network of communicatively connected communications devices;
a survey communicated to at least one of the communications devices by at least one other of the communications devices;
a response to the survey made by the at least one of the communications devices; and
a processor for handling the response.

2. A method of collecting information, comprising the steps of:
designing an electronically communicatable survey;
transmitting the survey electronically;
responding to the survey by an electronically communicatable response;
transmitting the response electronically; and
processing the response.
